(19) United States
(12) Patent Application Publication
(10) Pub. No.: US 2015/0234364 A1
(43) Pub. Date: Aug. 20, 2015

(54) METHOD FOR OPERATING KITCHEN APPLIANCE

(71) Applicant: General Electric Company, Schenectady, NY (US)

(72) Inventors: William Everette Gardner, Louisville, KY (US); Keith Wesley Wait, Louisville, KY (US)

(73) Assignee: General Electric Company, Schenectady, NY (US)

(21) Appl. No.: 14/181,773

(22) Filed: Feb. 17, 2014

(51) Int. Cl. G05B 11/01; G05B 15/02

(52) U.S. Cl. CPC G05B 11/01; G05B 15/02

(57) ABSTRACT

Methods for operating kitchen appliances are provided. A method includes detecting a user's presence, and associating the user's presence with a preference profile for the user, the preference profile comprising a stored setting preference for the kitchen appliance. The method further includes adjusting a setting of the kitchen appliance to correspond to the associated stored setting preference. The detecting step, the associating step and the adjusting step are performed by a controller of the kitchen appliance.

### FIELD OF THE INVENTION

The present subject matter relates generally to methods for operating kitchen appliances, and more particularly to methods which detect a user's presence and automatically configure to various preferences for the user based on this presence.

### BACKGROUND OF THE INVENTION

Kitchens are utilized generally for a variety of tasks by a variety of users. For example, a kitchen may include a refrigerator, a microwave, an oven, a dishwasher, a toaster, and/or a coffee maker, along with other various appliances. Each appliance is utilized for a different purpose. Further, multiple users may utilize the appliances in a kitchen during the course of a day, week, etc.

One frequent criticism common to the various appliances in a kitchen is the difficulty and/or latency in utilizing basic settings of the appliance. For example, a user is generally required to enter the kitchen and approach an appliance that the user desires to utilize. The user may then be required to evaluate various current settings of the appliance, and modify these settings if required, just to enable the user to utilize the basic functions of the appliance. Additionally or alternatively, a user may be required to activate the appliance and then wait for a period of time for the appliance to perform a required function. For example, use of a toaster appliance requires manual adjustment of the darkness preference. Use of a coffee maker requires activating the coffee maker and then waiting for the coffee to brew. Use of a refrigerator to dispense water requires selection of ice versus water, crushed ice versus ice cubes, etc.

Accordingly, improved methods for utilizing kitchen appliances are desired. In particular, methods for operating kitchen appliances which allow the kitchen appliance to detect a user's presence and automatically modify various settings based on preferences for that user would be advantageous.

### BRIEF DESCRIPTION OF THE INVENTION

In accordance with one embodiment of the present disclosure, a method for operating a kitchen appliance is disclosed. The method includes detecting a user's presence, and associating the user's presence with a preference profile for the user, the preference profile comprising a stored setting preference for the kitchen appliance. The method further includes adjusting a setting of the kitchen appliance to correspond to the associated stored setting preference. The detecting step, the associating step and the adjusting step are performed by a controller of the kitchen appliance.

In accordance with another embodiment of the present disclosure, a method for operating a kitchen appliance is disclosed. The method includes detecting an user's initial presence, and forming a stored setting preference for the kitchen appliance based on initial user modification of a setting of the kitchen appliance. The method further includes detecting a user's subsequent presence, and associating the user's subsequent presence with a preference profile for the user, the preference profile comprising the stored setting preference for the kitchen appliance. The method further includes adjusting a setting of the kitchen appliance to correspond to the associated stored setting preference, and modifying the stored setting preference based on a subsequent user modification of the setting of the kitchen appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave appliance mounted to a kitchen cabinet above an oven appliance in accordance with one embodiment of the present disclosure;

FIG. 2 provides a front, elevation view of an exemplary refrigerator appliance in accordance with one embodiment of the present disclosure;

FIG. 3 provides a front, perspective view of a dishwasher appliance in accordance with one embodiment of the present disclosure;

FIG. 4 provides a perspective view of a toaster appliance in accordance with one embodiment of the present disclosure;

FIG. 5 provides a front view of a coffee maker appliance in accordance with one embodiment of the present disclosure;

FIG. 6 is a schematic view of a kitchen appliance and associated independent storage device in accordance with one embodiment of the present disclosure; and

FIG. 7 is a flow chart of a method in accordance with one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

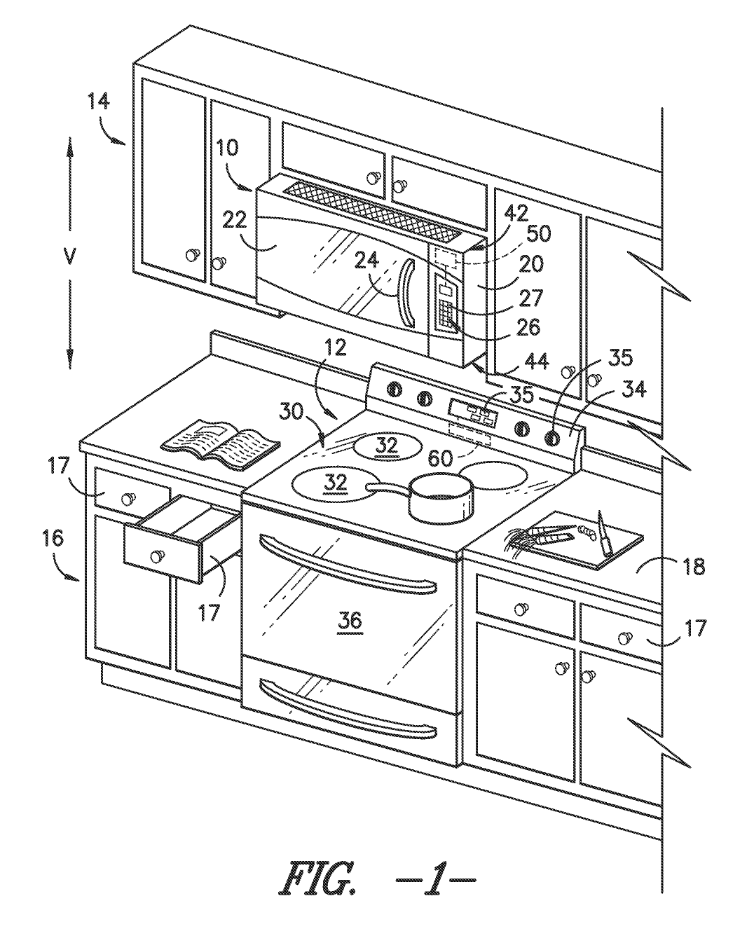

FIG. 1 provides a perspective view of a microwave appliance 10 according to an exemplary embodiment of the present subject matter mounted to an upper set of kitchen cabinets 14 above an oven appliance 12, e.g., along a vertical direction V. Microwave appliance 10 shown in FIG. 1 is commonly referred to as an over-the-range microwave. Upper set of kitchen cabinets 14 is positioned above a base set of kitchen cabinets 16, e.g., along the vertical direction V. Base set of kitchen cabinets 16 includes countertops 18 and drawers 17. Microwave appliance 10 is positioned above base set of kitchen cabinets 16, e.g., along the vertical direction V. Oven appliance 12 is received within base set of kitchen cabinets 16 below microwave appliance 10. In particular, a cooking surface 30 of oven appliance 12 is positioned, e.g., directly, below microwave appliance 10 along the vertical direction V. Microwave appliance 10 can include features such as an air handler or fan that can draw cooking vapors and/or smoke away from cooking surface 30 and out of the kitchen containing microwave and oven appliances 10 and 12.

Microwave appliance 10 is configured for receipt of food items for cooking. In particular, microwave appliance 10 includes a cabinet or casing 20 and a door 22 that permits selective access to an interior of microwave appliance 10 and casing 20. Door 22 includes a handle 24 that a user can pull to open door in order to insert food items into microwave appliance 10. Microwave appliance 10 also includes user interface panel 26 that permit a user to make selections for cooking of food items, e.g., a duration of a cooking cycle of microwave appliance 10 and/or a power setting for the cooking cycle of microwave appliance 10. In one embodiment, the user interface panel 26 may represent a general purpose I/O (“GPIO”) device or functional block. In one embodiment, the user interface panel 26 may include user interface features 27, such as one or more of a variety of electrical, mechanical or electro-mechanical input devices including rotary dials, push buttons, and touch pads. The user interface panel 26 may include a display component, such as a digital or analog display device designed to provide operational feedback to a user.

As discussed above, oven range appliance 12 includes cooking surface 30. Cooking surface 30 includes heated portions 32 that may be heated by heating elements (not shown), e.g., electrical resistive heating elements, gas burners, induction heating elements, and/or any other suitable heating element of combination of heating elements. Oven range appliance 12 also includes a door 36 that permits access to a heated compartment (not shown) of oven range appliance 12, e.g., for cooking or baking of food items therein. A user interface panel 34 of oven range appliance 12 can permit a user to make selections for cooking of food items, e.g., a duration of a cooking cycle of oven range appliance 12 and/or a power setting for the cooking cycle of oven range appliance 12. In one embodiment, the user interface panel 34 may represent a general purpose I/O (“GPIO”) device or functional block. In one embodiment, the user interface panel 34 may include user interface features 35, such as one or more of a variety of electrical, mechanical or electro-mechanical input devices including rotary dials, push buttons, and touch pads. The user interface panel 34 may include a display component, such as a digital or analog display device designed to provide operational feedback to a user.

It should be understood that microwave appliance 10 and oven appliance 12 are provided by way of example only. Thus, the present subject matter is not limited to microwave appliance 10 and oven appliance 12 and may be utilized in any suitable microwave and oven appliances.

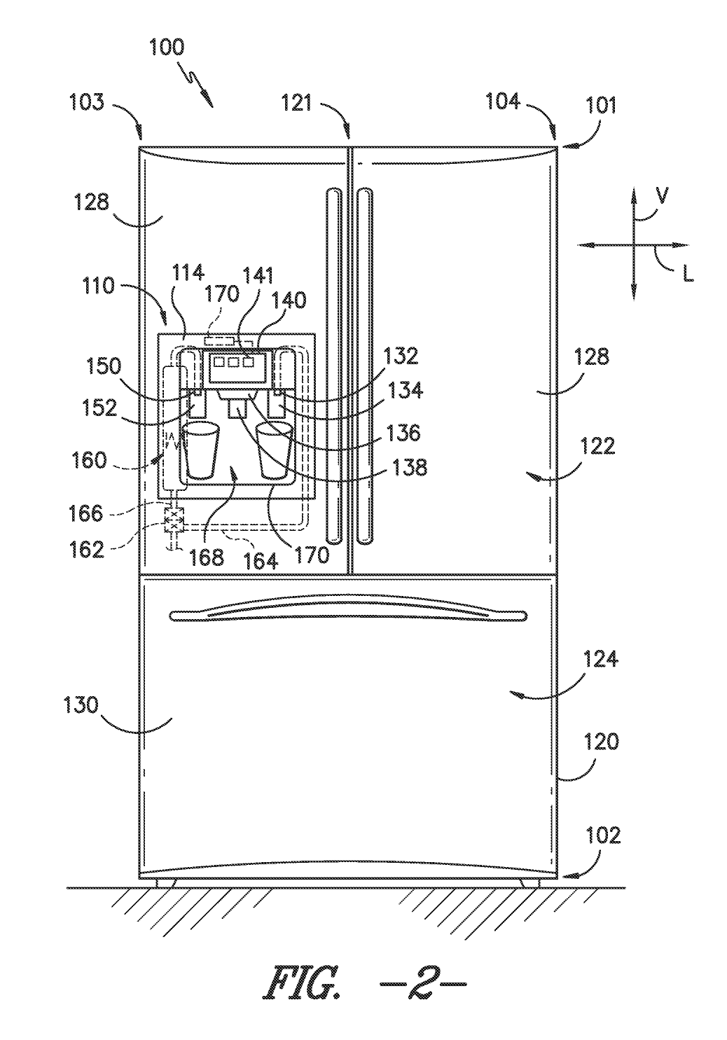

FIG. 2 provides a front, elevation view of a refrigerator appliance 100 according to an exemplary embodiment of the present subject matter. Refrigerator appliance 100 includes a cabinet or housing 120. Housing 120 extends between an upper portion 101 and a lower portion 102 along vertical direction V and also extends between a first side portion 103 and a second side portion 104 along a lateral direction L. A transverse direction (not shown) may additionally be defined perpendicular to the vertical direction and lateral direction L. Housing 120 defines chilled chambers, e.g., a fresh food compartment 122 positioned adjacent upper portion 101 of housing 120 and a freezer compartment 124 arranged at lower portion 102 of housing 120. Housing 120 also defines a mechanical compartment (not shown) for receipt of a sealed cooling system for cooling fresh food compartment 122 and freezer compartment 124.

Refrigerator appliance 100 is generally referred to as a bottom mount refrigerator appliance. However, it should be understood that refrigerator appliance 100 is provided by way of example only. Thus, the present subject matter is not limited to refrigerator appliance 100 and may be utilized in any suitable refrigerator appliance. For example, one of skill in the art will understand that the present subject matter may be used with side-by-side style refrigerator appliances or top mount refrigerator appliances as well.

Refrigerator doors 128 are rotatably hinged housing 120, e.g., at an opening 121 that permits access to fresh food compartment 122, in order to permit selective access to fresh food compartment 122. A freezer door 130 is arranged below refrigerator doors 128 for accessing freezer compartment 124. Freezer door 130 is mounted to a freezer drawer (not shown) slidably coupled within freezer compartment 124.

Refrigerator appliance 100 may also include a dispensing assembly 110 for dispensing various fluids, such as liquid water and/or ice to, for example, a dispenser recess 168 defined on one of refrigerator doors 128. Dispensing assembly 110 includes a dispenser 114 positioned on an exterior portion of refrigerator appliance 100. Dispenser 114 includes several outlets for accessing ice, chilled liquid water, and heated liquid water. As will be understood by those skilled in the art, liquid water from a water source, such as a well or municipal water system, can contain additional substances or matter. Thus, as used herein, the term “water” includes purified water and solutions or mixtures containing water and, e.g., elements (such as calcium, chlorine, and fluorine), salts, bacteria, nitrates, organics, flavor additives and other chemical compounds or substances.

To access ice, chilled liquid water, and heated liquid water, water-dispensing assembly 110 may for example include a chilled water paddle 134 mounted below a chilled water outlet 132 for accessing chilled liquid water and a heated water paddle 152 mounted below a heated water outlet 150 for accessing heated liquid water. Similarly, an ice paddle 138 is mounted below an ice outlet 136 for accessing ice. As an example, a user can urge a vessel such as a cup against any of chilled water paddle 134, heated water paddle 152, and/or ice paddle 138 to initiate a flow of chilled liquid water, heated liquid water, and/or ice into the vessel within dispenser recess 168, respectively.

A user interface panel 140 may be provided for controlling the mode of operation of dispenser 114, e.g., for selecting crushed or whole ice. In one embodiment, the user interface panel 140 may represent a general purpose I/O (“GPIO”) device or functional block. In one embodiment, the user interface panel 140 may include user interface features 141, such as one or more of a variety of electrical, mechanical or electro-mechanical input devices including rotary dials, push buttons, and touch pads. The user interface panel 140 may include a display component, such as a digital or analog display device designed to provide operational feedback to a user.

In additional exemplary embodiments, refrigerator appliance 100 may include a single outlet and paddle rather than three separate paddles and dispensers. In such embodiments, user interface panel 140 can include a chilled water dispensing button (not labeled), an ice-dispensing button (not labeled), a heated water dispensing button (not labeled), and a steam-dispensing button (not labeled) for selecting between chilled liquid water, ice, heated liquid water, and steam, respectively.

Outlets 132, 136, and 150 and paddles 134, 138, and 152 may be an external part of dispenser 114, and are positioned at or adjacent dispenser recess 168, e.g., a concave portion defined in an outside surface of refrigerator door 128. Dispenser 114 is positioned at a predetermined elevation convenient for a user to access ice or liquid water, e.g., enabling the user to access ice without the need to bend-over and without the need to access freezer compartment 124. In the exemplary embodiment, dispenser 114 is positioned at a level that approximates the chest level of a user.

Refrigerator appliance 100 may also include features for generating heated liquid water and/or steam and directing such heated liquid water and/or steam to, for example, dispenser recess 168. Thus, refrigerator appliance 100 need not be connected to a residential hot water heating system in order to supply heated liquid water and/or steam to dispenser recess 168. In particular, refrigerator appliance 100 includes a fluid heating assembly 160 which may for example be mounted within refrigerator door 128 for heating water therein. Refrigerator appliance 100 may include a tee-joint 162 for splitting a flow of water. Tee-joint 162 directs water to both a heated water conduit 166 and a chilled water conduit 164.

Heated water conduit 166 is in fluid communication with fluid heating assembly 160 and heated water outlet 150. Thus, water from tee joint 162 can pass through fluid heating assembly 160 and exit refrigerator appliance 100 at heated water outlet 150 as heated liquid water or steam. Conversely, chilled water conduit 164 is in fluid communication with chilled water outlet 132. Thus, water from tee-joint 162 can exit refrigerator appliance 100 as chilled liquid water at chilled water outlet 132. In alternative exemplary embodiments, chilled water conduit 164 and heated water conduit 166 are joined such that chilled and heated water conduits 164 and 166 are connected in parallel or in series to each other and dispense fluid at dispenser recess 168 from a common outlet.

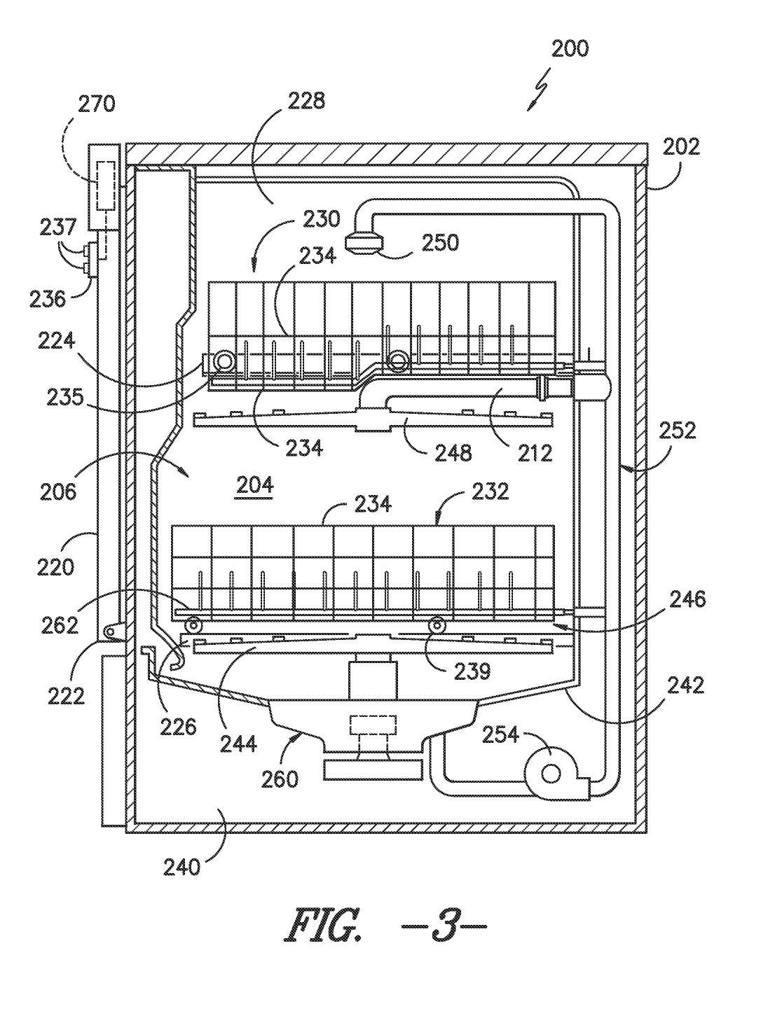

FIG. 3 depicts an exemplary domestic dishwasher appliance 200 that may be configured in accordance with aspects of the present disclosure. For the particular embodiment of FIG. 1, the dishwasher appliance 200 includes a cabinet 202 having a tub 204 therein that defines a wash chamber 206. Chamber 206 is configured for the receipt of articles for cleaning, such as dishes, cups, utensils, etc. The tub 204 includes a front opening (not shown) and a door 220 hinged at or near its bottom side wall 222 for movement between a normally closed vertical position, wherein the wash chamber 206 is sealed shut for washing operation, and a horizontal open position for loading and unloading of articles from the dishwasher appliance 200.

Upper and lower guide rails 224, 226 are mounted on tub side walls 228 and accommodate roller-equipped rack assemblies 230 and 232. Each of the rack assemblies 230, 232 may be fabricated into lattice structures including a plurality of elongated members 234 (for clarity of illustration, not all elongated members making up assemblies 230 and 232 are shown). Each rack 230, 232 is adapted for movement between an extended loading position (not shown) in which the rack is substantially positioned outside the wash chamber 206, and a retracted position (shown) in which the rack is located inside the wash chamber 206. This is facilitated by rollers 235 and 239, for example, mounted onto racks 230 and 232, respectively. A silverware basket (not shown) may be removably attached to rack assembly 232 for placement of silverware, utensils, and the like, that are otherwise too small to be accommodated by the racks 230, 232.

The dishwasher appliance 200 further includes a lower spray-arm assembly 244 that is rotatably mounted within a lower region 246 of the wash chamber 206 and above a tub sump portion 242 so as to rotate in relatively close proximity to rack assembly 232. A mid-level spray-arm assembly 248 is located in an upper region of the wash chamber 206 and may be located in close proximity to upper rack 230. Additionally, an upper spray assembly 250 may be located above the upper rack 230.

The lower and mid-level spray-arm assemblies 244, 248 and the upper spray assembly 250 are fed by a fluid circulation conduit 252 for circulating water and dishwasher fluid (generally referred to as liquid) in the tub 204. A first pump 254, which may for example be located in a machinery compartment 240 located below the bottom sump portion 242 of the tub 204, may flow liquid to and through the fluid circulation conduit 252. Each spray-arm assembly 244, 248 includes an arrangement of discharge ports or orifices for directing washing liquid onto dishes or other articles located in rack assemblies 230 and 232. The arrangement of the discharge ports in spray-arm assemblies 244, 248 provides a rotational force by virtue of washing fluid flowing through the discharge ports. The resultant rotation of the lower spray-arm assembly 244 provides coverage of dishes and other dishwasher contents with a washing spray.

Door 220 may include a user interface panel 236 through which a user may select various operational features and modes and monitor progress of the dishwasher 200. In one embodiment, the user interface panel 236 may represent a general purpose I/O (“GPIO”) device or functional block. In one embodiment, the user interface panel 236 may include user interface features 237, such as one or more of a variety of electrical, mechanical or electro-mechanical input devices including rotary dials, push buttons, and touch pads. The user interface panel 236 may include a display component, such as a digital or analog display device designed to provide operational feedback to a user.

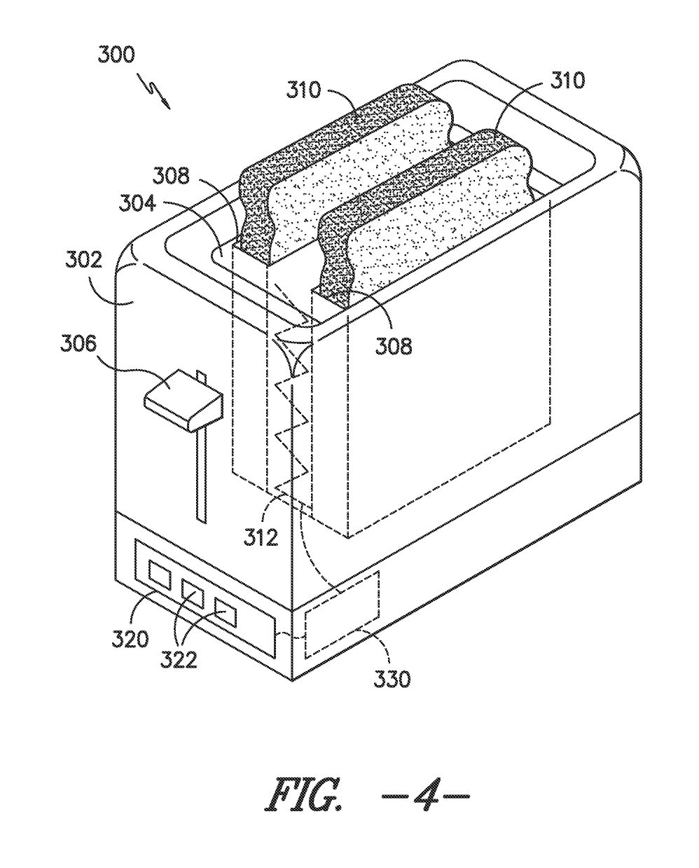

FIG. 4 illustrates an exemplary toaster appliance 300. Toaster appliance includes a housing 302 having a toasting compartment 304, and a carriage 306. The toasting compartment 304 is provided with two slots 308 at its top for receiving food items 310, such as bread, to be toasted. One or more electric heating units 312 are disposed in the toasting compartment 304, and may extend between the slots 308 for toasting the food items 310. The carriage 306 is operable so as to move between an upper position (illustrated) and a lower position. When the carriage 306 is disposed in the upper position, the electric heating units 312 are deactivated. When the carriage 306 is moved to the lower position, the electric heating units 312 are activated so as to toast the food items 310 loaded in the carriage 306. Generally, the carriage 306 can be moved automatically from the lower position to the upper position in a known manner after a predetermined toasting cycle.

Toaster appliance 300 may further include a user interface panel 320 through which a user may select various operational features and modes for the toaster appliance. For example, a user may utilize user interface panel 320 to select a darkness preference, which may correlate to a time during which the electric heating units 312 may be active and the carriage 306 may remain in the lower position after being moved to such position. In one embodiment, the user interface panel 320 may represent a general purpose I/O (“GPIO”) device or functional block. In one embodiment, the user interface panel 320 may include user interface features 322, such as one or more of a variety of electrical, mechanical or electro-mechanical input devices including rotary dials, push buttons, and touch pads. The user interface panel 320 may include a display component, such as a digital or analog display device designed to provide operational feedback to a user.

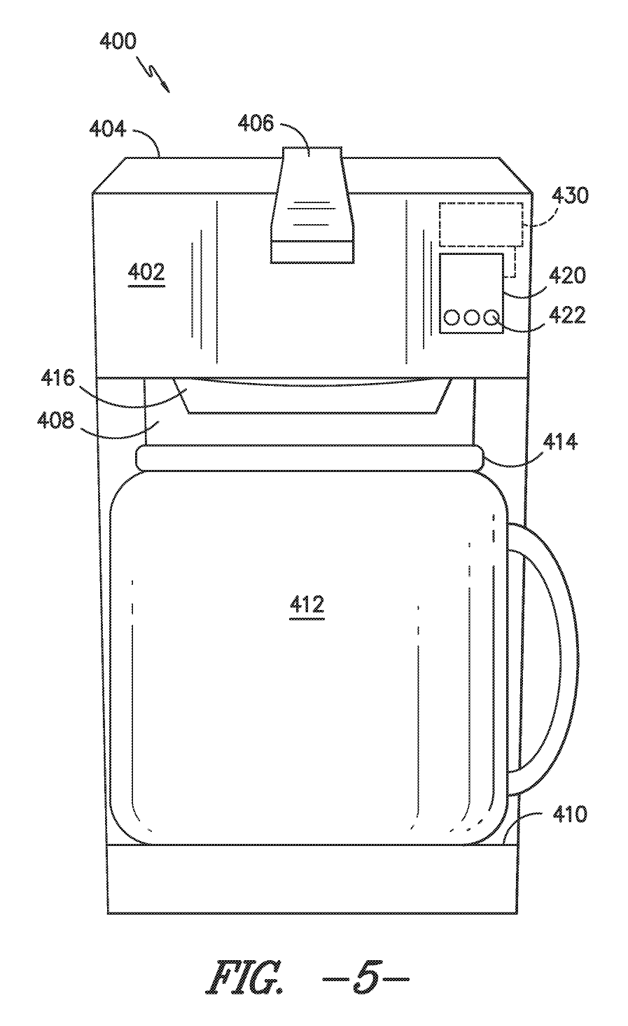

FIG. 5 illustrates an exemplary coffee maker appliance 400. The coffee maker appliance 400 includes a body 402, an opening lid 404, a lid handle 406, a water container 408, and a platform 410. A coffee pitcher 412 rests on the platform 410 and has a pitcher lid 414. The coffee maker appliance 400 provides a flow of hot water through coffee grounds to produce a coffee drink. Water is flowed from container 408 through a tube (not shown) to a coffee container 416 (accessed through lid 404) and through the container 416 to pitcher 412. The flow of water may be heated by one of any known means, for example, an electrical heating coil disposed in the container 408 or a conductive coating on tubing carrying the water.

Coffee maker appliance 400 may further include a user interface panel 420 through which a user may select various operational features and modes for the toaster appliance. For example, a user may utilize user interface panel 420 to activate the appliance 400 or set a timer for activation of the appliance 400. In one embodiment, the user interface panel 420 may represent a general purpose I/O (“GPIO”) device or functional block. In one embodiment, the user interface panel 420 may include user interface features 422, such as one or more of a variety of electrical, mechanical or electro-mechanical input devices including rotary dials, push buttons, and touch pads. The user interface panel 420 may include a display component, such as a digital or analog display device designed to provide operational feedback to a user.

Referring again to FIGS. 1 through 4, the various appliances 10, 12, 100, 200, 300, 400 may each include a controller 50, 60, 170, 270, 330, 430, respectively. The user interface panels of each appliance may be may be in communication with the respective controller for that appliance via, for example, one or more signal lines or shared communication busses. Input/output (“I/O”) signals may be routed between a controller and various operational components of the respective appliance. Operation of the appliances can be regulated by the respective controllers that are operatively coupled to the respective user interface panels. A user interface panel may for example provide selections for user manipulation of the operation of an appliance. In response to user manipulation of the user interface panel, such as of the user interface features thereof, the controller may operate various components of the appliance. Controller 50, 60, 170, 270, 330, 430 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

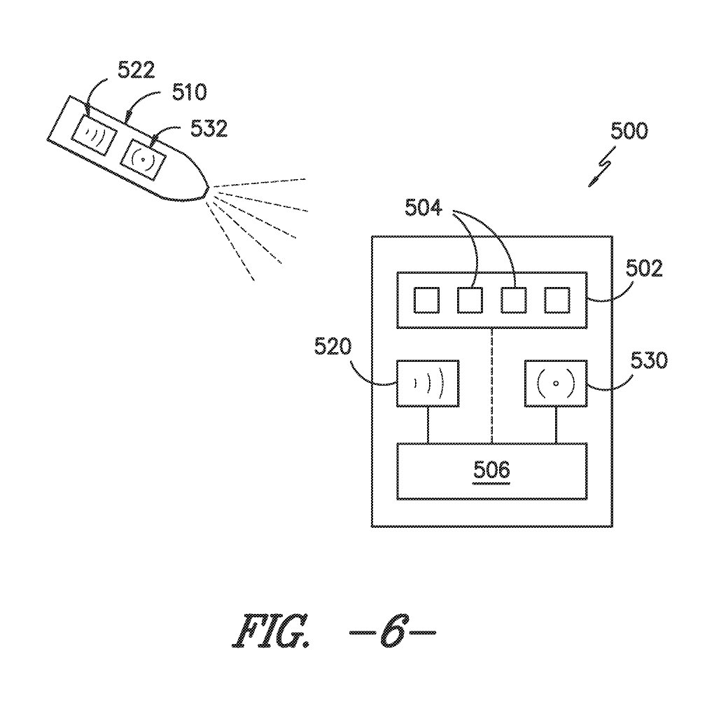

FIG. 6 is a schematic illustration of a generic kitchen appliance 500 and an independent storage device 510 for use with such kitchen appliance 500. The kitchen appliance 500 may, for example, be a microwave appliance 10, oven appliance 12, refrigerator appliance 100, dishwasher appliance 200, toaster appliance 300, coffee maker appliance 400, or any other suitable appliance which may generally be utilized in a kitchen. Kitchen appliance 500 includes a user interface panel 502, which may be user interface panel 26, 34, 140, 236, 320, or 420, or another suitable user interface panel. User interface panel 502 may include user interface features 504, which may be user interface features 27, 35, 141, 237, 322 or 422, or other suitable user interface features. Kitchen appliance 500 may further include a controller 506, which may be in operable communication with user interface panel 502 and may be controller 50, 60, 170, 270, 330, 430 or another suitable controller.

As discussed herein, a preference profile for one or more users for one or more kitchen appliances 500 may be saved and stored, such as in the controller 506 or in the independent storage device 510. The preference profile may include stored setting preferences for one or more kitchen appliances 500 which correlate to the user's preferences for settings on the kitchen appliances 500. An independent storage device 510 may, for example, be an independent device such as a “dongle” that the user carries with him/her. In other embodiments a device 510 may be a component of another suitable device that the user carries with him/her, such as a cellular phone, etc. In still other embodiments, a device 510 may be a digital storage drive, such as a “cloud”-based storage. The device 510 may be in communication with the controller 506, such that the information is transmittable between the controller 510 and device 506. Such communication may be facilitated through, for example, a suitable wired or wireless connection.

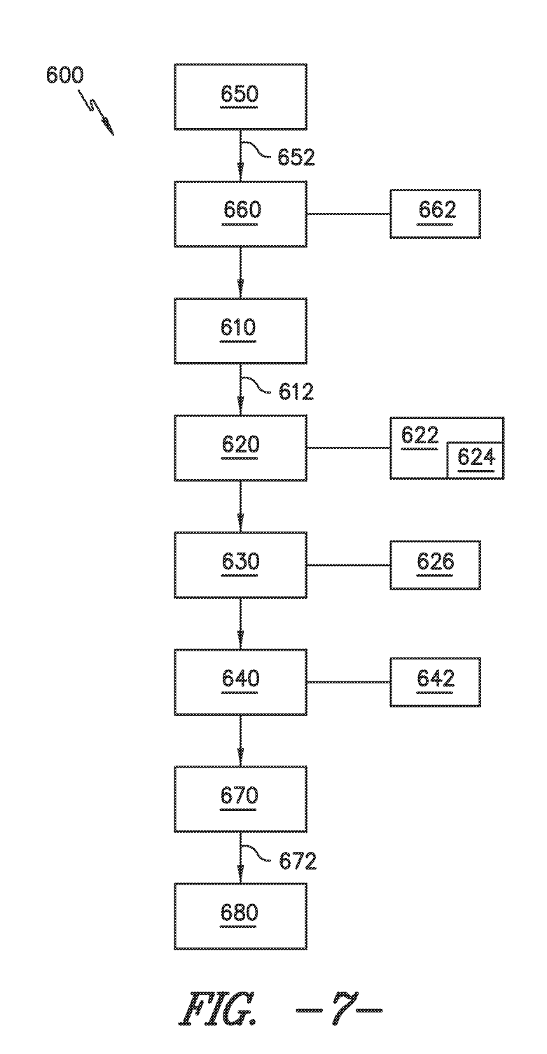

Referring now to FIG. 6 as well as FIG. 7, the present disclosure is further directed to methods for operating kitchen appliances 500. Such methods advantageously allow the kitchen appliances 500 to detect a user's presence and automatically modify various settings thereof based on preferences for that user. For example, a method 600 according to the present disclosure may include the step 610 of detecting a user's presence 612. The presence of such user may be an individualized presence, such that the kitchen appliance 500 distinguishes the user from other users. Such presence detection may be performed in a number of manners. For example, in some embodiments, radio frequency identification detection (“RFID”) or near field communication (“NFC”) detection may be utilized, via suitable sensors and readers. An RFID reader 520 or NFC reader 530, for example, may be provided in the kitchen appliance 500, and a user of the refrigerator appliance may wear or possess an RFID sensor 522 or NFC sensor 532, conventionally described as a tag (not shown). The tag may for example be included in independent storage device 510, or may be a separate component. Sensor reader 520, 530 may be configured for receiving a signal from the associated sensor 522, 532. Thus, the reader 520, 530 and sensor 522, 532 can be in signal communication with each other. As an example, the sensor 522, 532 may be a passive tag. Thus, sensor reader 520, 530 can receive a radio signal from such tag in response to a query or request signal from sensor reader 520, 530. In particular, such tag can generate or transmit the response radio signal utilizing energy transmitted, e.g., wirelessly, to the tag from sensor reader 520, 530 via the query or request signal from sensor reader 520, 530. Thus, the tag need not include a battery or other power source in order to generate or transmit the response radio signal. As another example, the tag can include a battery or be connected to a suitable power source, and can continuously or intermittently generate or transmit a signal that sensor reader 520, 530 can receive. As will be understood, sensor reader 520, 530 and the tag can have any other suitable setup or configuration for placing sensor reader 520, 530 and the tag in signal communication with each other. Thus, sensor reader 520, 530 may be passive or active, and the tag may be passive or active depending upon the desired setup. The sensor reader 520, 530 may be in communication with or integral with the controller 506, such that controller 506 is operable to detect a user's presence.

In other embodiments, biometric detection may be utilized, such as via a biometric sensor provided in the kitchen appliance 500. The biometric sensor may, for example, recognize and distinguish various visual characteristics of individual users, such as facial characteristics. The sensor may thus, for example, include a camera which records images or videos, and may further include suitable biometric software for processing such images or videos. Such camera and software may be in communication with or integral with controller 506, such that controller 506 is operable to detect a user's presence. Suitable examples of such biometric technology may be commercially available from, for example, Cognitec Systems GmbH, with a headquarters in Dresden, Germany, and through, for example, OpenCV, such as at http://docs.opencv.org/trunk/modules/contrib/doc/facerec/.

In other embodiments, audio detection may be utilized, such as via an audio sensor provided in the kitchen appliance 500. The audio sensor may, for example, recognize and distinguish various audio characteristics of individual users, such as voice characteristics. The sensor may thus, for example, include a microphone which receives and/or records audio transmissions, and may further may further include suitable audio software for processing such transmissions. Such microphone and software may be in communication with or integral with controller 506, such that controller 506 is operable to detect a user's presence. Suitable examples of such audio technology may be commercially available from, for example, Nuance Communications, Inc., with a headquarters in Burlington, Mass.; CSID, with a headquarters in Austin, Tex.; Auraya Systems, with a headquarters in Nashua, N.H.; TradeHarbor, Inc., with a headquarters in St. Louis, Mo.; Voxeo Corporation, with a headquarters in Orlando, Fla.; and AGNITiO Corp, with a headquarters in Arlington, Va.

In still other embodiments, any other suitable detection apparatus may be utilized to facilitate the detection of a user by kitchen appliance 500. Bluetooth technology is another suitable example of such detection apparatus. In general, suitable detection apparatus facilitates the detection of a user's presence and the distinction of that user's presence from the presences of other users, due to the actual detection of the user's presence or the detection of the presence of a device, such as an independent storage device 510, associated with the user. In exemplary embodiments, controller 506 at least in part performs such detection, utilizing the suitable detection hardware and software provided in the kitchen appliance 500 and in communication or integral with the controller 506.

Accordingly, utilizing various suitable apparatus such as that disclosed herein, a user's presence 612 may be detected, such as by controller 506. In exemplary embodiments, the user's presence 612 may be detected when the user's is a certain distance from the kitchen, and thus from the kitchen appliance(s) 500 which include controller(s) 506. For example, the user's presence 612 may be detected as the user approaches the kitchen.

A method according to the present disclosure may further, for example, include the step 620 of associating the user's presence 612 with a preference profile 622 for the user. The preference profile 622 generally includes one or more stored setting preferences 624 for one or more kitchen appliances 500. Stored setting preferences 624 are generally specific user preferences for settings 626 on the kitchen appliances 500. The settings 626 of kitchen appliances 500 thus are generally modifiable to associated stored setting preferences 624 for each individual user. Settings 626 can be, for example, user preferences, appliances functions, and/or activations of kitchen appliances 500. Examples of settings 626 include, for example, a darkness user preference for a toaster appliance 300, an ice type user preference for a refrigerator appliance 100, a water temperature user preference for a refrigerator appliance 100, an activation preference for a coffee maker appliance 400 (for example, a preference that the coffee maker appliance 400 be activated during a particular time period, such as morning, when the user's presence 612 is detected), and an appliance function preference for, for example, a dishwasher appliance 200, a microwave appliance 10, and/or an oven appliance 12 (for example, a preference for a particular function, such as a particular cycle or combination of cycles for dishwasher appliance 200, a particular heating cycle for microwave appliance 10 (such as reheat, etc.), or a particular heating cycle for oven appliance 12 (such as heating to a particular temperature). Stored setting preferences 624 are generally user preferences for such settings 626. It should be understood that the present disclosure is not limited to such settings 626, and rather that any suitable settings 626 for any suitable kitchen appliance are within the scope and spirit of the present disclosure.

In some embodiments, the preference profile 622 and associated stored setting preferences 624 may be stored in the controller 506. In other embodiments, the preference profile 622 and associated stored setting preferences 624 may be stored in the independent storage device 510. Controller 506 may in exemplary embodiments associate the user's presence 612 with a preference profile 622 for the user, by for example utilizing the stored preference profile 622 after the user's presence 612 is detected or communicating with the independent storage device 510 after the user's presence 612 is detected.

A method according to the present disclosure may further include, for example, the step 630 of adjusting one or more settings 626 of one or more kitchen appliances 500 to correspond to associated stored setting preferences 624. Thus, each setting 626 for which an associated stored setting preference 624 is included in the preference profile 622 for the detected user's presence 612 may be adjusted to that stored setting preference 624. For example, a darkness user preference for a toaster appliance 300 may be adjusted to a specific darkness, an ice type user preference for a refrigerator appliance 100 may be adjusted to a specific ice type, a water temperature user preference for a refrigerator appliance 100 may be adjusted to a specific water temperature, a coffee maker appliance 400 may be activated, a particular cycle may be associated with a particular user interface feature 504 as a “hot key” for a dishwasher appliance 200, a microwave appliance 10, and/or an oven appliance 12, etc. Such step 630 may in exemplary embodiments be performed automatically upon associating the user's presence 612 with a preference profile 622 for the user. Further, in exemplary embodiments, controller 506 may perform such step 630.

Further, in some embodiments, a method according to the present disclosure may facilitate modification of the stored setting preferences 624 for the user. Thus, a method may include the step 640 of modifying one or more stored setting preferences 624 based on user modification 642 of the associated setting(s) 626 of the kitchen appliance(s) 500. For example, during the course of repeated uses of a kitchen appliance 500, the user may manually adjust a setting 626 from the stored setting preference 624 to which the setting 626 was automatically adjusted. Such adjustment may indicate a change in the user's preferences with respect to that setting 626. Accordingly, the stored setting preference 624 may update to the manually selected setting preference by the user, and thus be modified based on such user modification 642. Such modification may occur after each user modification 642, or after a predetermined number of user modifications 642. The modification may be to the manually selected setting preference, or to a modified stored setting preference 624 that is, for example, an average of a number of user modifications 642. Accordingly, the stored setting preferences 624 may update and “learn” based on user modification 642. Further, in exemplary embodiments, controller 506 may perform such step 640.

Further, in some embodiments, a method according to the present disclosure may facilitate initial learning of stored setting preferences 624 for the user. In these embodiments, the user's presence 612 may be the user's subsequent presence. The method may include the step 650 of detecting the user's initial presence 652, which may be a presence the first time that the kitchen appliance 500 is utilized to detect a user's presence upon initial use of the kitchen appliance 500 or use after a reset of the kitchen appliance 500, for example. Such step 650 may be performed similarly to detection of the user's subsequent presence 612, as discussed above. The method may further include the step 660 of forming the stored setting preference(s) 624 for the kitchen appliance(s) 500 based on initial user modification 662 of the setting(s) 626 of the kitchen appliance(s) 500. Initial user modification 662 may be similar to user modification 642 (which may in these embodiments be subsequent user modification) as discussed above. Accordingly, based on the initial user modifications 662, the stored setting preference(s) 624 may be set for subsequent use in automatically adjusting associated settings 626. Further, in exemplary embodiments, controller 506 may perform such steps 650, 660.

Still further, in some embodiments, a method according to the present disclosure may include safety features to prevent kitchen appliances 500 from operating or otherwise remaining active after a user leaves the kitchen or otherwise moves such that the user's presence 612 is no longer detected by the kitchen appliances 500. Accordingly, a method according to the present disclosure may further include, for example, the step 670 of detecting an absence 672 of the user's presence 612. Such absence 672 may occur when, for example, the user's presence 612 is no longer detectable by the kitchen appliance(s) 500. The method may further include, for example, the step 680 of deactivating the kitchen appliance(s) 500 upon detection of the absence 672. Thus, the appropriate kitchen appliance(s) 500 may, for example, be automatically turned off or into a sleep mode or passive mode when the user's presence 612 is no longer detectable. In exemplary embodiments, controller 506 may perform such steps 670, 680.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for operating a kitchen appliance, the method comprising:
detecting a user's presence;
associating the user's presence with a preference profile for the user, the preference profile comprising a stored setting preference for the kitchen appliance; and
adjusting a setting of the kitchen appliance to correspond to the associated stored setting preference;
wherein the detecting step, the associating step and the adjusting step are performed by a controller of the kitchen appliance.

2. The method of claim 1, further comprising modifying the stored setting preference based on user modification of the setting of the kitchen appliance.

3. The method of claim 1, further comprising:
detecting an absence of the user's presence; and
deactivating the kitchen appliance upon detection of the absence.

4. The method of claim 1, wherein the user's presence is the user's subsequent presence, and further comprising:
detecting a user's initial presence; and
forming the stored setting preference for the kitchen appliance based on user modification of the setting of the kitchen appliance.

5. The method of claim 1, wherein the detecting step utilizes one of radio frequency identification detection or near field communication detection.

6. The method of claim 1, wherein the preference profile is stored in the controller.

7. The method of claim 1, wherein the preference profile is stored in an independent storage device.

8. The method of claim 1, wherein the setting is a user preference.

9. The method of claim 1, wherein the setting is an appliance function.

10. The method of claim 1, wherein the setting is activation of the kitchen appliance.

11. The method of claim 1, wherein the kitchen appliance is a toaster appliance, and wherein the setting is a darkness user preference.

12. The method of claim 1, wherein the kitchen appliance is a refrigerator appliance, and wherein the setting is one of an ice type user preference or a water temperature user preference.

13. The method of claim 1, wherein the kitchen appliance is one of a dishwasher appliance, a microwave appliance or an oven appliance, and wherein the setting is an appliance function.

14. The method of claim 1, wherein the kitchen appliance is a coffee maker appliance, and wherein the setting is activation of the coffee maker appliance.

15. The method of claim 1, wherein the stored setting preference is a plurality of stored setting preferences.

16. A method for operating a kitchen appliance, the method comprising:
detecting an user's initial presence;
forming a stored setting preference for the kitchen appliance based on initial user modification of a setting of the kitchen appliance;
detecting a user's subsequent presence;
associating the user's subsequent presence with a preference profile for the user, the preference profile comprising the stored setting preference for the kitchen appliance;
adjusting a setting of the kitchen appliance to correspond to the associated stored setting preference; and
modifying the stored setting preference based on a subsequent user modification of the setting of the kitchen appliance.

17. The method of claim 16, further comprising:
detecting an absence of the user's presence; and
deactivating the kitchen appliance upon detection of the absence.

18. The method of claim 16, wherein the detecting step utilizes one of radio frequency identification detection or near field communication detection.

19. The method of claim 16, wherein the preference profile is stored in the controller.

20. The method of claim 16, wherein the preference profile is stored in an independent storage device.
